(19) United States
(12) Patent Application Publication
(10) Pub. No.: US 2014/0317154 A1
(43) Pub. Date: Oct. 23, 2014

(54) HETEROGENEOUS DATA MANAGEMENT METHODOLOGY AND SYSTEM

(71) Applicant: TraxlD, LLC, Dallas, TX (US)

(72) Inventor: Duke Loi, Frisco, TX (US)

(73) Assignee: TraxlD, LLC, Dallas, TX (US)

(21) Appl. No.: 14/206,455

(22) Filed: Mar. 12, 2014

Related U.S. Application Data
(60) Provisional application No. 61/791,046, filed on Mar. 15, 2013.

(51) Int. Cl. G06F 17/30

(52) U.S. Cl. CPC G06F 17/30289
USPC 707/807

(57) ABSTRACT

A system for storing and processing heterogeneous data comprises a common data layer configured to manage and store abstracted data using a standard relational database, the common data layer comprises a template repository storing a plurality of data-logic templates and user data. The system further includes a data abstraction layer comprising rules for processing user data and handling a user-interface, an intelligence layer comprises context sensitive processing logic of user inputs and data from the data abstraction layer according to the data-logic templates, and a user interface layer configured to present the processed data and capture user inputs for the system.

### RELATED APPLICATION

The present application claims the benefit of U.S. Provisional Patent Application Ser. No. 61/791,046 filed on Mar. 15, 2013.

### FIELD

The present disclosure primarily relates to a heterogeneous data management methodology and system.

### BACKGROUND

In traditional software design, datasets are created specifically for predefined data fields and types. In order to manage heterogeneous data in a system, either multiple datasets are created for different data types, or a large dataset is used to encompass all possible data fields of every possible data types. These approaches are inefficient and inflexible to change.

### DESCRIPTION OF THE DRAWINGS

FIG. 1 is a block diagram illustrating the architecture of the heterogeneous data management methodology and system according to the teachings of the present disclosure;

FIG. 2 is a block diagram illustrating an exemplary dynamically mapped dataset of the heterogeneous data management methodology and system according to the teachings of the present disclosure;

FIG. 3 is a block diagram illustrating an exemplary format for the data record or data table of the heterogeneous data management methodology and system according to the teachings of the present disclosure;

FIG. 4 is a diagram illustrating an exemplary detail data section record or table of the heterogeneous data management methodology and system according to the teachings of the present disclosure;

FIGS. 5-7 are screen captures of exemplary data displays according to the to the teachings of the present disclosure;

FIG. 8 is a diagram illustrating an exemplary general data section record or table of the heterogeneous data management methodology and system according to the teachings of the present disclosure; and

FIG. 9 is a simplified block diagram of an exemplary environment in which the heterogeneous data management methodology and system are adapted to operate.

### DETAILED DESCRIPTION

A new and unconventional system and method of managing heterogeneous data is described in this disclosure. This heterogeneous data management methodology enables a software system to manage and store heterogeneous data homogeneously in a single system and data structure. For example, different work order types with different data sizes can be stored in the same common data layer. Storage utilization is maximized by only storing data fields that are relevant to the assets or work orders. Adding new assets (e.g., oil well, motor, pipe) or work order types (e.g., service motor, inspect pipe, install motor, etc.) does not require a complete makeover of the database tables, but instead, the addition can be handled dynamically and incrementally without taking the entire system offline. Thus, this methodology provides great expandability and adaptability to system implementation. Furthermore, the intelligent data management layer provides additional data abstraction and protection.

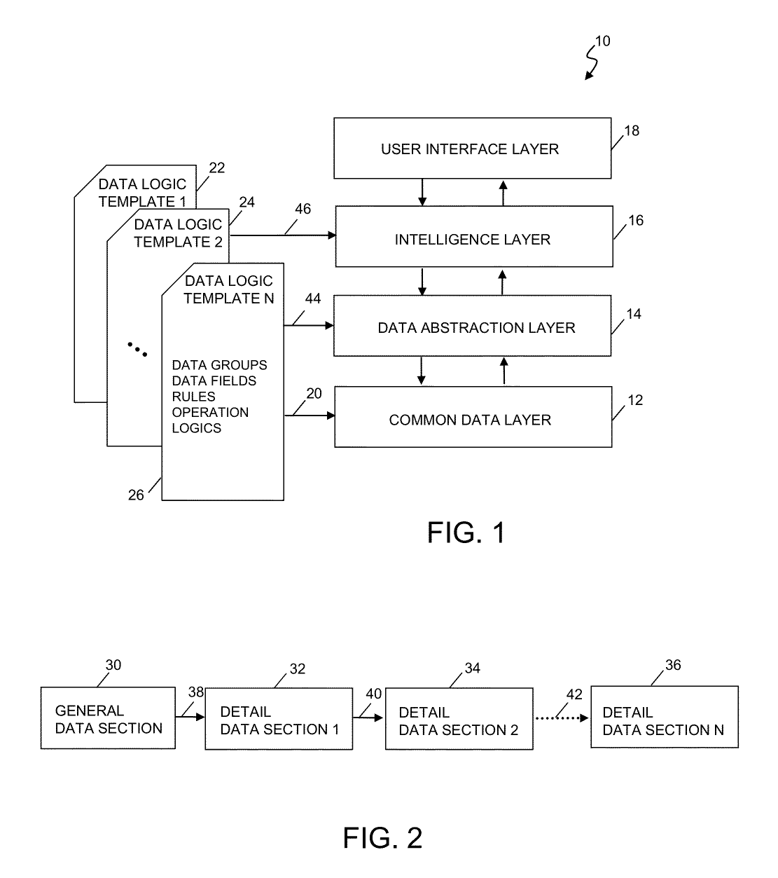

This software methodology 10 for managing heterogeneous asset and work-order data includes four functional layers: common data layer 12, data abstraction layer 14, intelligence layer 16, and user interface layer 18. These layers 12-18 are driven by data-logic templates 20-24 which are defined for each asset or work order type, as shown in FIG. 1.

Each data-logic template 20-24 defines the data groups, data fields, rules, and operation logics for an asset category or work order type. Thus, one system uniformly manages multiple categories of assets and work order types, and enables cross-template updates according to their predefined rules and operation logics. Adding a new asset category or work order type to an existing system is possible by adding a new template. In short, a data-logic template defines how the system should handle an asset category or work order type, and how the data of one template interacts with other templates.

Therefore, data are validated and processed according to a data-logic template of a specific data object type, data are also abstracted according to a data-logic template of a specific data object type, and data are extracted based on extracting rules that are defined in a data-logic template of a specific data object type.

The first layer is the common data layer 12 which manages and stores abstracted data using standard relational database system. It includes a template repository and user data. The template repository stores all data-logic templates 20-24 of the system 10. The system 10 uses these data-logic templates 20-24 to create screens, tabs, and data fields at the user interface layer 18, and to process the data at the intelligence layer 16. The user data is structured and stored according to the database schemas 20 of the data abstraction layer 14 and the data-logic templates 22-26.

User data of different data object types are encoded and stored in the same set of common database tables. Each data record is stored in a dynamically mapped dataset which contain a general data section 30 and one or more linked detail data sections 32-36, as shown in FIG. 2. Detail data sections 32-36 are linked to the general data section 30 and to one another by the detail section pointers 38-42. The general purpose of the General Data Section 30 is to provide the system a consistent way to process and search all work orders regardless of their work order types. Thus, data fields within the General Data Section 30 are consistently named and defined. The general data section 30 contains key data fields that are used by the system to identify, locate, and interpret subsequence detail datasets. The detail data sections contain data-logic defined datasets that can only be interpreted by data-logic template definitions.

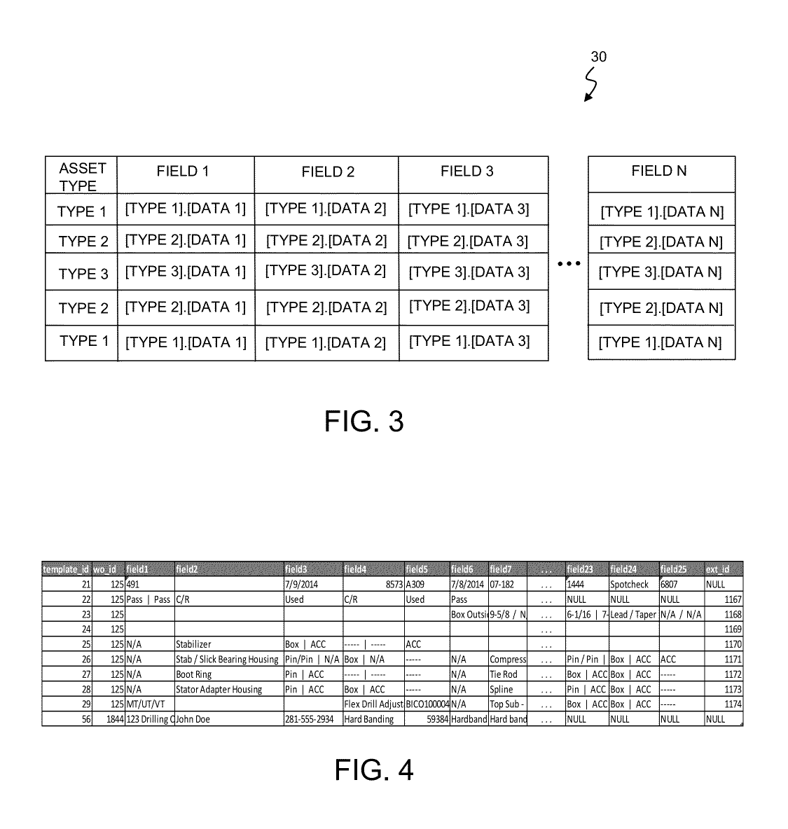

FIG. 3 is an exemplary drawing of a detail data section which illustrates the same database column can store different data from different data object types with different data types and attributes. For example, a drill pipe data object type and a mud motor data object type can store different data in the same database column of the same database table.

The layer above the common data layer 12 is the data abstraction layer 14. It provides rules to the layers 16 and 18 above for processing user data and handling the user-interface. In addition, it encodes and decodes user data to and from the common data layer 12 according to the data definitions 44. The data abstraction layer 14 places a field name and rules to a detail field and allows the layers above to correctly process the data. The data abstraction layer 14 allows different types of data stored in the same database column for different asset or work order types, as shown in FIG. 3. Thus, this data storing method maximizes the database table utilization and enables new addition of asset categories and work order types without adding database tables and the programming changes to the existing system.

The intelligence layer 16 provides context-sensitive logic and processing of user input and data from the data abstraction layer 14 according to the data-logic templates 22-26. The data processing includes, but not limited to, data validation, data updates/postings, calculations, screen controlling, and report generation. The intelligence layer 16 retrieves data and screen processing rules 46 dynamically from the corresponding template 24 on demand.

The last layer of the model is the user interface layer 18 which presents the processed data and captures user inputs for the system. The screen and field layouts are controlled by the intelligence layer 16 based on the data-logic template definition 46 of an active asset category or work order type. A system can have different screen layouts and data fields for different asset categories and/or work order types. This simplifies and unclutters the screens, and only presents necessary information to the user.

Different work order types with different data sizes can be stored in the same common data layer 12. FIG. 4 is an exemplary work order detail 32-36 that contains data records from two different work order types: tool inspection and tool servicing. This tool inspection work order type example has many data fields, which occupies 9 rows of record and each record contains 25 data fields and system controlling fields. By looking at the rows of data in the common data layer 12, field1 from one row has no corresponding meaning to field1 in another row. For example, field1 of first row contains a serial number of an inspection coil, and field1 of second row contains inspection results of an asset. Further, field1 of the last row contains a customer name of a service work order.

The data abstraction layer 14 interprets or manages each data field according to the predefined definition of the templates 26. Thus, the system controls where to save the data, how to display them, and what business logics should be applied to them. Without the data abstraction layer 14 and the corresponding templates 26, the system would not know how to manage the data, and all data become meaningless to the system and the users. Above the data abstraction layer 14, the intelligence layer 16 applies data processing logics and formatting rules 24 to the data when they are entered by the user or retrieved from the system. The intelligence layer 16 performs according to the corresponding template and instructs the user interface layer 18 on how to display the data and their field labels.

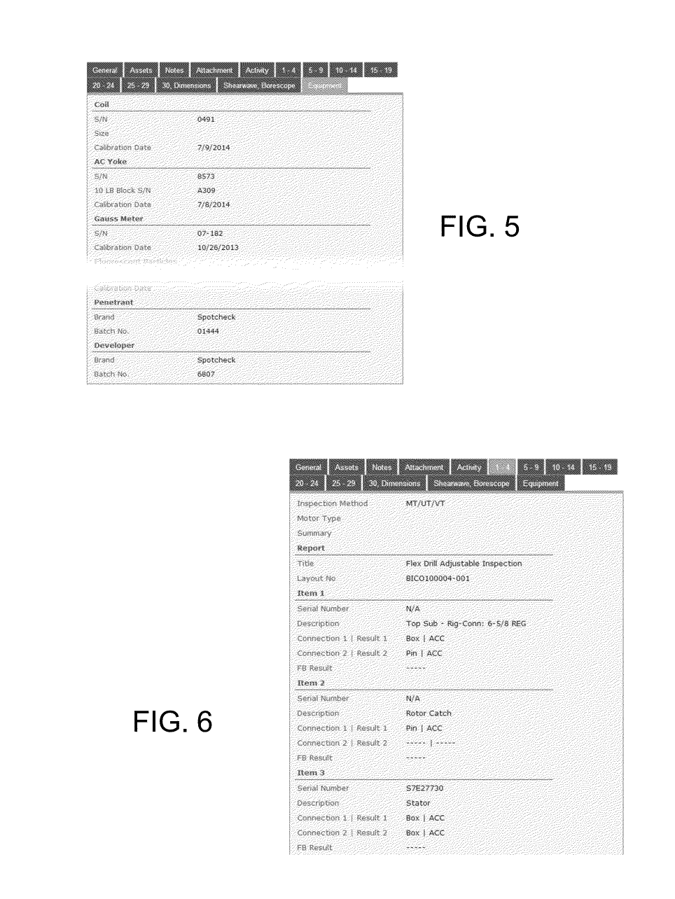

As shown in FIGS. 5-7, the data from the previous example are displayed differently according to the templates. The data from field1 of the first row in FIG. 4 is shown as serial number under the “Coil” section with the field label of “S/N.” The data from field1 of row 9 (second to last row) in FIG. 4 is shown and interpreted as a method of inspection in FIG. 6, and displayed with the field label of “Inspection Method.” These fields are displayed as read-only fields due to the definitions of Tool Inspection work order template. However, data from field1 of last row in FIG. 4 is shown as customer name in FIG. 7 with the field label of “Customer.” This field is read/write field to permit the user to enter or edit the data as it is defined in Service work order template.

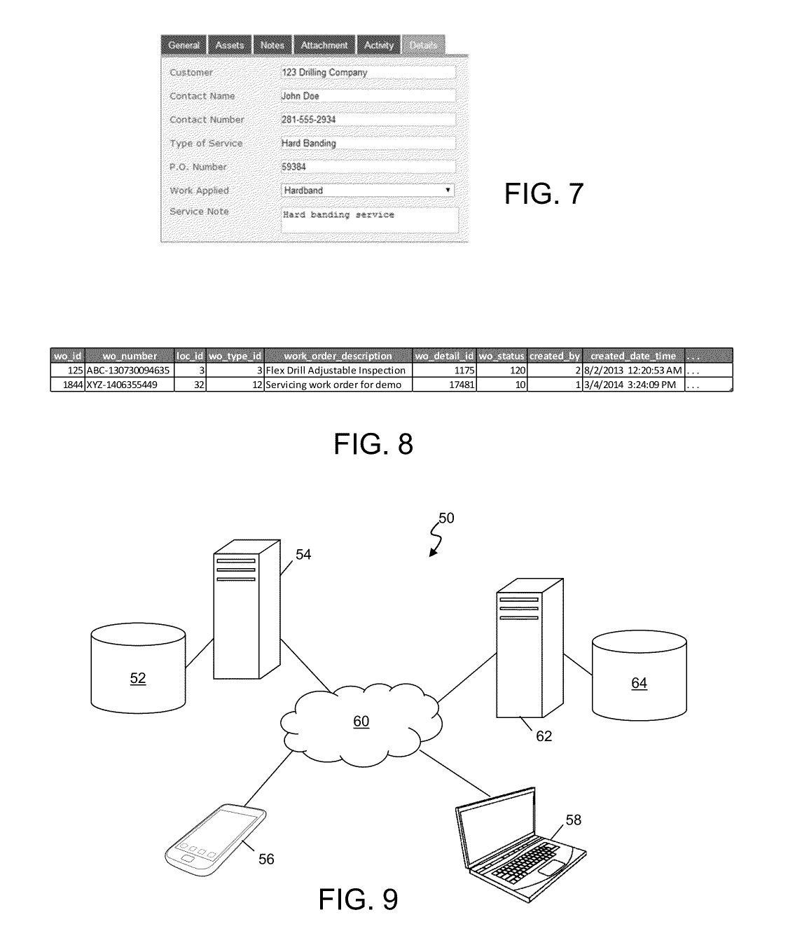

FIG. 4 illustrates a Detail Data Section as shown in FIG. 2. The Detail Data Sections 32-36 can be one or many as defined in each template. Thus, the General Data Section 30 allows the system to find the Detail Data Sections 32-36 by linking them, as shown in FIG. 2 and FIG. 8 below. FIG. 8 illustrates the General Data Section 30 with a common system data field for work orders and the Detail Data Section link in work order detail ID field (wo_detail_id). In the first row of the data record shown in FIG. 8, the work order detail ID has a value of 1175 (not shown in the table) which links to row 9 (second to the last row) of FIG. 4. The extension field (next to last field) in row 9 links to 1174 which is the row right above it. The links continue until reaching the first row of FIG. 4 which has a value of NULL, that is the end of the Detail Data Section for that particular work order with Tool Inspection work order type. FIGS. 5-7 show various detail data tabs on the screen (after the Activity tab). They are shown because of the Intelligence Layer and the Tool Inspection work order template. The Intelligence Layer relays the template definition to the User Interface Layer which draws the corresponding tabs, field labels, field, titles, and their formats.

The general purpose of the General Data Section 30 is to provide the system a consistent way to process and search all work orders regardless of their work order types. Thus, data fields within the General Data Section 30 are consistently named and defined; i.e. second field of row 1 has the same data type as row 2, where both are work order numbers, for example.

FIG. 9 is a simplified block diagram of an exemplary environment 50 in which the heterogeneous data management methodology and system are adapted to operate. The database 52 in which user data and data-logic templates are stored may be accessed by a server 54, which is further accessible by users using various types of computing devices 56 and 58, which may be, for example, mobile telephones, tablet computers, GOOGLE glasses, laptops, desktop computers, and other forms of computing devices now known and later developed. The communication medium 60 may be wired and wireless, and implement any number of known and future communication protocols. The communication medium 60 may be part of a local area network, wide area network, the Internet, and other computer networks. The database 52 and server 54 may be mirrored in one or more servers 62 and databases 64.

The present disclosure relates to a heterogeneous data management system comprises data-logic templates which defines: how different data types are stored and managed in common database tables for different assets or work orders; data sets that include field names, data types, data attributes, and rules for each types of assets or work orders; and data interaction between work order data and asset data.

The present disclosure relates to creating new screens and data fields by importing a data-logic template file without programming or database changes.

The present disclosure relates to different data fields that are stored in common database tables that are shared by different object types (i.e. assets or work orders) at the common data layer.

The present disclosure relates to data abstraction layer that applies data field names, data types, data attributes, and rules to the raw data in common data layer based on predefined data-logic template of a specific asset or work order type.

The present disclosure relates to an intelligence layer that manages how data fields interact with each other based on the data-logic templates.

The present disclosure relates to a user interface layer that present each data field according to data-logic template definition and how the system validates the user input.

The features of the present invention which are believed to be novel are set forth below with particularity in the appended claims. However, modifications, variations, and changes to the exemplary embodiments described above will be apparent to those skilled in the art, and the system and method described herein thus encompasses such modifications, variations, and changes and are not limited to the specific embodiments described herein.

What is claimed is:

1. A system for storing and processing heterogeneous data comprising:
a common data layer configured to manage and store abstracted data using a standard relational database, the common data layer comprises a template repository storing a plurality of data-logic templates and user data;
a data abstraction layer comprising rules for processing user data and handling a user-interface;
an intelligence layer comprises context sensitive processing logic of user inputs and data from the data abstraction layer according to the data-logic templates; and
a user interface layer configured to present the processed data and capture user inputs for the system.

2. The system of claim 1, wherein data-logic templates are adapted to define data types, data attributes, and rules for each data type, and rules for data interaction between different data types.

3. The system of claim 1 wherein the data-logic templates are adapted to define how different data types are stored and managed in common database tables for different assets and work orders.

4. The system of claim 1 wherein the data-logic templates are adapted to define data sets including field names, data types, data attributes, and rules for each data type.

5. The system of claim 1 further comprising different data fields stored in common database tables that are shared by different object types at the common data layer.

6. The system of claim 1 wherein the data abstraction layer is adapted to apply data field names, data types, data attributes, and rules to the raw data in common data layer based on predefined data-logic template of a specific asset or work order type.

7. The system of claim 1 wherein the user interface layer is adapted to present each data field according to data-logic template definition and how the system validates the user input.

8. The system of claim 1 wherein the common data layer comprises:
a general data section containing key data fields used to identify, locate and interpret detail data sections; and
at least one detail data section containing data-logic defined datasets that can be interpreted by data-logic template definitions.

9. The system of claim 8 wherein the common data layer further comprises data pointers linking the general data section and the at least one detail data section.

10. A system for processing heterogeneous data comprising:
a common data layer including a plurality of data-logic templates defining data types, data attributes, and rules for data interaction between different data types;
an abstraction layer comprising rules for processing user data and handling a user-interface;
an intelligence layer comprises context sensitive processing logic of user inputs and data from the data abstraction layer according to the data-logic templates; and
a user interface layer adapted to present the processed data and capture user inputs for the system.

11. The system of claim 10, wherein the data-logic templates are adapted to define how different data types are stored in common database tables for different assets categories and work order types.

12. The system of claim 10 further comprising different data fields stored in common database tables that are shared by different object types at the common data layer.

13. The system of claim 12 wherein the data abstraction layer is adapted to apply data field names, data types, data attributes, and rules to the raw data in common data layer based on predefined data-logic template of a specific asset or work order type.

14. The system of claim 10 wherein the user interface layer is adapted to present each data field according to data-logic template definition.

15. The system of claim 10 wherein the user interface layer is adapted to validate user input according to the data-logic template definition.

16. The system of claim 10 wherein the common data layer comprises:
a general data section containing key data fields used to identify, locate and interpret detail data sections; and
at least one detail data section containing data-logic defined datasets that can be interpreted by data-logic template definitions.

17. The system of claim 16 wherein the common data layer further comprises data pointers linking the general data section and the at least one detail data section.

18. A method of managing heterogeneous data comprising:
providing data-logic templates which defines how data types are stored and managed in common database tables for different assets or work orders, data sets that include field names, data types, data attributes, and rules for each types of assets or work orders, and data interaction between work order data and asset data;
storing data according to the data-logic template definitions;
processing data according to the data-logic template definitions;
displaying data fields according to the data-logic template definitions; and
receiving and validating user input according to the data-logic template definitions.

19. The method of claim 18, wherein storing data comprises storing data in a a common data layer including a general data section containing key data fields used to identify, locate and interpret detail data sections, and at least one detail data section containing data-logic defined datasets that can be interpreted by data-logic template definitions.

20. The method of claim 18, further comprising encoding and decoding data stored in a common data layer according to the data-logic template definitions.
